(19) United States
(12) Patent Application Publication
(10) Pub. No.: US 2008/0302472 A1
(43) Pub. Date: Dec. 11, 2008

(54) Process for making a laminate, and process for making a carton from the laminate

(76) Inventors: Mohamed Ali Barakat, Overijse (BE); Wolfram Beck, Strombeek-Bever (BE); Neil John Rogers, Vilvoorde (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/072,933

(22) Filed: Feb. 29, 2008

(30) Foreign Application Priority Data
Mar. 1, 2007 (EP) 07103283.3
Mar. 1, 2007 (EP) 07103284.1

(51) Int. Cl. B32B 38/14; B29C 47/06

(52) U.S. Cl. 156/244.16

(57) ABSTRACT

The present invention relates to a process for making a laminate comprising paperboard and plastic film, and a non-aqueous adhesive layer between the paperboard and the plastic film, the process comprising the steps of:

(a) surface oxidation treatment of at least one side of the plastic film; and

(b) extrusion laminating the plastic film to the paperboard;

wherein the non-aqueous adhesive layer is applied by extrusion between the plastic film and the paperboard to form the laminate, and wherein the process further comprises the step of printing inks onto the surface oxidation treated surface of the plastic film either before or after the extrusion lamination step; and to a process for making a carton, whereby the carton is erected from a blank which is formed from the laminate.

The present invention relates to a process for making a laminate comprising paperboard and plastic film, and further relates to a carton, whereby the carton is erected from a blank which is formed from the laminate. The laminate, and cartons formed therefrom, are particular suitable for packing goods, especially consumer goods, in packages which may be decoratively presented such as to be appealing to the consumer at the point of sale and at the point of use.

Laminates made from paper and plastic film are known in the packaging industry.

U.S. Pat. No. 6,083,580, issued on Jul. 4, 2000, discloses a container having walls made of a paper/plastic laminate. Optionally, the outer surface of the plastic layer is made receptive to inks and printing. The paper and plastic film are glued together using a water-based adhesive which is then cured.

However water-based adhesives are unsuitable for laminating some substrates to some films. For example water-based adhesives are unsuitable for economically laminating rough surfaces of paperboard, such as grey board, “GK” or “URB”, to plastic films.

The aim of the present invention is to provide a process for making a laminate comprising paperboard and plastic film, at least one film surface of which is receptive to inks and printing, and which can be carried out in a single lamination process. This avoids the added expense of either a further corrugation step, or a further lamination step, such as disclosed in U.S. Pat. No. 6,083,580.

### SUMMARY OF THE INVENTION

The present invention relates to a process for making a laminate comprising paperboard and plastic film, and a non-aqueous adhesive layer between the paperboard and the plastic film, the process comprising the steps of:
(a) surface oxidation treatment of at least one side of the plastic film; and
(b) extrusion laminating the plastic film to the paperboard;
   wherein the non-aqueous adhesive layer is applied by extrusion between the plastic film and the paperboard to form the laminate, and wherein the process further comprises the step of printing inks onto the surface oxidation treated surface of the plastic film either before or after the extrusion lamination step.

Preferably the paperboard is grey board, preferably the plastic film is polypropylene, and preferably the non-aqueous adhesive layer comprises polyethylene.

The present invention further relates to a process for making a carton, whereby the carton is erected from a blank which is formed from the laminate as described above, the process comprising the step of adhering at least one area of the carton to at least one other area of the carton, the surfaces which are adhered together being surfaces of the plastic film which have been subject to surface oxidation.

### DETAILED DESCRIPTION OF THE INVENTION

By “paperboard” what is meant herein is any planar substrate made essentially from cellulosic fibres. Paperboard useful in the present invention has a basis weight of at least 250 grams per square meter, preferably at least 300 grams per square meter, and more preferably at least 350 grams per square meter. Preferably the thickness of the paperboard is from 500 to 800 micrometers. Paper board may be grey board, either surface coated or uncoated; or solid bleached board. Bleached board generally has a smoother and more aesthetically pleasing surface, but grey board is preferred herein for reasons of lower cost.

By “plastic film” what is meant herein is any film made essentially from thermoplastic material. For example, polypropylene, polyethylene, or polyethylene terephthalate may be used. Polypropylene, or polyethylene terephthalate are preferred. Polypropylene, especially oriented polypropylene is most preferred. Preferably the thickness of the plastic film is from 10 to 30 micrometers. The film may be in the form of sheet or a web.

By “non-aqueous adhesive layer” what is meant herein is any material which is suitable for adhering together the paperboard and the plastic film. A preferred material is polyethylene. Preferably the thickness of the adhesive layer is from 10 to 40 micrometers, most preferably from 15 to 25 micrometers.

By “surface oxidation treatment” what is meant herein is the surface treatment of a thermoplastic substrate on at least one side to increase its surface energy by ionizing a neutral fluid, such as air, by creating a plasma around an electrode of high potential. Ions which are generated by this process pass charge to nearby areas of low potential, which leads to surface oxidation of the substrate and to increased surface energy expressed in mN/m or dyn/cm. The surface energy after surface oxidation is preferably at least 36 mN/m (36 dyn/cm), and more preferably from 40 to 55 mN/m (40 to 55 dyn/cm). A preferred method of surface treatment is known as corona discharge treatment or air plasma treatment. Other known technologies in the industry which have a similar process and effect include surface oxidation treatment by atmospheric (air) plasma, flame plasma and chemical plasma systems.

For example, surface treatment may be based upon gas phase priming technology which is commercialized by Air Liquide under the trade mark of Aldyne. Aldyne® effectively replaces more conventional liquid primer coatings on a plastic substrate. The technology provides a monolayer of molecular primer coating, preferably having a thickness of less than 1 nm, preferably 0.3 to 0.4 nm. The high presence of nitrogen based polar groups, such as amines, amides or imides, on the surface of the material (typically in the range of 4% to 9%) confers high surface energy, and thereby excellent wettability and adhesion. The nitrogen based polar groups create stable hydrogen or covalent bonding with the binders of the inks, varnish or adhesive formulations improving adhesion and avoiding delamination while handling or using the final product. See “Aldyne™: surface treatment by atmospheric plasma for plastic films converting industry” published in Surface and Coatings Technology, Volumes 174-175, September-October 2003, pages 899-901.

By “extrusion laminating” what is meant herein is the gradual melting of the thermoplastic resin that is used as adhesive and which is fed into an extruder in granular or powder form until it becomes an essentially homogeneous fluid. The molten resin is cast through a die between the paperboard and the plastic film and run over cylinders where the extrudate is cooled and solidified. Preferably the cylinders are chilled to accelerate the cooling process and avoid undesirable effects on the laminated materials, such as shrinkage, holes or melting.

The laminates and cartons of the present invention are particularly suitable for adapting to consumer needs for an attractive package. For example the package may be given visual features, including printing effects, metallization effects, holographic effects, and/or may be given tactile features, including soft touch effects.

Printing effects are enhanced in the present invention by printing inks onto surfaces which have been treated by surface oxidation, for example corona treated. The surface oxidation treatment raises the surface energy of polypropylene, for example from about 32 mN/m (32 dyn/cm) up to at least 36 mN/m (36 dyn/cm), and preferably into the range of from 40 to 55 mN/m (40 to 55 dyn/cm). This provides a more economical means for effectively printing inks onto the polypropylene surface than alternative, known means, such as applying a chemical treatment, such as an acrylic coating, to the polypropylene. Standard printing techniques including gravure printing, flexographic printing or lithographic (offset) printing, may be used. Reverse printing may also be used to provide a printed layer which is on the side of the film which contacts the non-aqueous adhesive layer.

Metallization effects can be achieved by sublimating aluminium under vacuum and depositing it onto the substrate resulting in a metallised layer. The metallised layer being preferably applied to the side of the plastic film that comes into contact with the non-aqueous adhesive layer. Vacuum deposition is one process to achieve such effects. The metallised layer is visible through parts of the film which are not printed, or only partly printed or printed with a non-opaque ink.

Soft touch effects may be achieved by micro-embossing the plastic film. If the micro-embossing technique is used then it is preferred that this method is used in conjunction with reverse printing as described above.

Alternatively soft touch effects may be achieved by incorporating silicate or other suitable inorganic materials into the film. The silicate-containing film by be used independently of, or in conjunction with, the micro-embossing technique described above. Soft touch effects may also be achieved by using a soft touch varnish in the printing process as final coating step when printing to the side of the film that is not in contact with the non-aqueous adhesive layer.

### EXAMPLE 1

A bioriented polypropylene film of thickness 15 micrometers, having one side metallised by the supplier, is obtainable from Poligal Vertriebs GmbH, Nidda/Ober-Schmitten, Germany, having the specification METE15SOL. The unmetallised side of the film is then subject to corona treatment and the surface energy raised to 42 mN/m (42 dyn/cm).

The treated film is extrusion laminated to grey board having a basis weight of 480 grams per square meter using a layer of clear polyethylene, 22 micrometers thick, to laminate the polypropylene film and the paper board together. The metallised side of the polypropylene film is in contact with the polyethylene adhesive layer, whilst the corona treated side is on the outside of the laminate.

The corona treated surface is then printed using a UV offset printing technique.

Carton blanks are cut from the laminate and folded and glued to form finished cartons.

### EXAMPLE 2

A bioriented polypropylene film of thickness 15 micrometers, having one side metallised by the supplier, is obtainable from Poligal Vertriebs GmbH, Nidda/Ober-Schmitten, Germany, having the specification METE15SOL. The unmetallised side of the film is then subject to surface treatment with Aldyne, a trademark of Air Liquide, and the surface energy raised to 42 mN/m (42 dyn/cm).

The treated film is extrusion laminated to grey board having a basis weight of 480 grams per square meter using a layer of clear polyethylene, 22 micrometers thick, to laminate the polypropylene film and the paper board together. The metallised side of the polypropylene film is in contact with the polyethylene adhesive layer, whilst the Aldyne® treated side is on the outside of the laminate.

The Aldyne® treated surface is then printed using a UV offset printing technique.

Carton blanks are cut from the laminate and folded and glued to form finished cartons.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a laminate comprising paperboard and plastic film, and a non-aqueous adhesive layer between the paperboard and the plastic film, the process comprising the steps of:
(a) surface oxidation treatment of at least one side of the plastic film; and
(b) extrusion laminating the plastic film to the paperboard;
characterized in that the non-aqueous adhesive layer is applied by extrusion between the plastic film and the paperboard to form the laminate, and wherein the process further comprises the step of printing inks onto the surface oxidation treated surface of the plastic film either before or after the extrusion lamination step.

2. A process for making a laminate according to claim 1 wherein the paperboard has a basis weight of at least about 250 grams per square meter, preferably the paperboard is grey board.

3. A process for making a laminate according to claim 1 wherein the non-aqueous adhesive layer comprises polyethylene.

4. A process for making a laminate according to claim 1 wherein the plastic film is polypropylene or polyethylene terephthalate.

5. A process for making a laminate according to claim 4 wherein the plastic film is micro-embossed.

6. A process for making a laminate according to claim 4 wherein the plastic film comprises inorganic material.

7. A process for making a laminate comprising paperboard and plastic film, and a non-aqueous adhesive layer between the paperboard and the plastic film, the process comprising the steps of:
(a) surface oxidation treatment of at least one side of the plastic film; and
(b) extrusion laminating the plastic film to the paperboard;
characterized in that the non-aqueous adhesive layer is applied by extrusion between the plastic film and the paperboard to form the laminate, and wherein the process further comprises the step of printing inks onto the surface oxidation treated surface of the plastic film either before or after the extrusion lamination step, and still further comprising the step of applying a metallised layer to the plastic film, the metallised layer being applied to the side of the film that comes into contact with the non-aqueous adhesive layer.

8. A process for making a laminate according to claim 7 wherein the paperboard has a basis weight of at least about 250 grams per square meter, preferably the paperboard is grey board.

9. A process for making a laminate according to claim 7 wherein the non-aqueous adhesive layer comprises polyethylene.

10. A process for making a laminate according to claim 7 wherein the plastic film is polypropylene or polyethylene terephthalate.

11. A process for making a laminate according to claim 10 wherein the plastic film is micro-embossed.

12. A process for making a laminate according to claim 10 wherein the plastic film comprises inorganic material.

13. A process for making a carton, whereby the carton is erected from a blank which is formed from the laminate comprising paperboard and plastic film, and a non-aqueous adhesive layer between the paperboard and the plastic film, the process comprising the steps of:
(a) surface oxidation treatment of at least one side of the plastic film; and
(b) extrusion laminating the plastic film to the paperboard;
characterized in that the non-aqueous adhesive layer is applied by extrusion between the plastic film and the paperboard to form the laminate, and wherein the process further comprises the step of printing inks onto the surface oxidation treated surface of the plastic film either before or after the extrusion lamination step, the process still further comprising the step of adhering at least one area of the carton to at least one other area of the carton, the surfaces which are adhered together being surfaces of the plastic film which have been subject to surface oxidation treatment.

14. A process for making a carton according to claim 13 wherein the paperboard has a basis weight of at least about 250 grams per square meter, preferably the paperboard is grey board.

15. A process for making a carton according to claim 13 wherein the non-aqueous adhesive layer comprises polyethylene.

16. A process for making a carton according to claim 13 wherein the plastic film is polypropylene or polyethylene terephthalate.

17. A process for making a carton according to claim 16 wherein the plastic film is micro-embossed.

18. A process for making a carton according to claim 16 wherein the plastic film comprises inorganic material.
